(19) United States
(12) Patent Application Publication
(10) Pub. No.: US 2026/0286485 A1
(43) Pub. Date: Sep. 24, 2026

(54) HIGH-STRENGTH STAINLESS STEEL SEAMLESS PIPE FOR OIL WELLS

(71) Applicant: JEF Steel Corporation, Chiyoda-ku, Tokyo (JP)

(72) Inventors: Kenichiro EGUCHI, Chiyoda-ku, Tokyo (JP); Shinsuke IDE, Chiyoda-ku, Tokyo (JP)

(73) Assignee: JEF Steel Corporation, Chiyoda-ku, Tokyo (JP)

(21) Appl. No.: 19/477,828

(22) PCT Filed: Apr. 11, 2024
(86) PCT No.: PCT/JP2024/014699

§ 371 Date: Oct. 23, 2025

(30) Foreign Application Priority Data
May 30, 2023 (JP) 2023-088996

(51) Int. Cl. C22C 38/48; C21D 6/00; C21D 9/08; C22C 38/00; C22C 38/02; C22C 38/04; C22C 38/06; C22C 38/42; C22C 38/44; C22C 38/46; C22C 38/50; C22C 38/52; C22C 38/54; C22C 38/58; C22C 38/60; E21B 17/00; F16L 9/02

(52) U.S. Cl. CPC C22C 38/48; C21D 6/004; C21D 6/005; C21D 6/007; C21D 6/008; C21D 9/085; C22C 38/001; C22C 38/002; C22C 38/004; C22C 38/005; C22C 38/008; C22C 38/02; C22C 38/04; C22C 38/06; C22C 38/42; C22C 38/44; C22C 38/46; C22C 38/50; C22C 38/52; C22C 38/54; C22C 38/58; C22C 38/60; E21B 17/00; F16L 9/02; C21D 2211/001; C21D 2211/008

(57) ABSTRACT

A high-strength stainless steel seamless pipe for oil wells has a chemical composition including specific components, the balance being Fe and incidental impurities. The chemical composition satisfies relation (1) and relation (2):

$$Cr + 0.22 \times Ni + 0.38 \times ( Mo + 0.5 \times W ) + 0.89 \times Cu + 0.09 \times Co \geq 21.4 \qquad ( 1 )$$

wherein Cr, Ni, Mo, W, Cu, and Co in relation (1) indicate the contents (mass %) of the respective elements and are zero when the element is absent,

$$Co - Nb \geq 0.13 \qquad ( 2 )$$

wherein Co and Nb in relation (2) indicate the contents (mass %) of the respective elements. The high-strength stainless steel seamless pipe has a yield strength of 758 MPa or more and an absorbed energy vE₋₁₀ in a Charpy impact test at a test temperature of −10° C. of 40 J or more.

### CROSS REFERENCE TO RELATED APPLICATIONS

This is the U.S. National Phase application of PCT/JP2024/014699, filed Apr. 11, 2024 which claims priority to Japanese Patent application No. 2023-088996, filed May 30, 2023, the disclosures of these applications being incorporated herein by reference in their entireties for all purposes.

### FIELD OF THE INVENTION

The present invention relates to a high-strength stainless steel seamless pipe for oil wells suitably used in, for example, crude oil wells or natural gas wells (hereinafter, these wells are collectively referred to as “oil wells”).

### BACKGROUND OF THE INVENTION

Ultradeep oil fields, or severely corrosive oil fields and gas fields in a so-called sour environment containing hydrogen sulfide and the like were long untouched but are actively developed in recent years on the background of escalating crude oil prices and also due to petroleum resources being expected to be depleted in the near future. In general, such oil fields and gas fields are found extremely deep in the ground and have a hot and severely corrosive atmosphere environment containing CO₂, Cl⁻, and H₂S. Materials for oil country tubular goods used in such an environment are required to have desired levels of high strength and corrosion resistance.

13Cr martensitic stainless steel pipes are heretofore used frequently as oil country tubular goods for extraction in oil fields and gas fields that are found in an environment containing carbon dioxide gas (CO₂), chloride ions (Cl⁻), and the like. Furthermore, 13Cr martensitic stainless steel has been improved by lowering of the C content and increasing of the contents of, for example, Ni and Mo. The use of such improved 13Cr martensitic stainless steel has also expanded in recent years.

For example, the techniques disclosed in Patent Literatures 1 to 5 address the demands described above.

Patent Literature 1 discloses a stainless steel pipe for oil country tubular goods that is improved in corrosion resistance by having a steel composition which includes, in mass %, C: 0.05% or less, Si: 0.50% or less, Mn: 0.20 to 1.80%, P: 0.03% or less, S: 0.005% or less, Cr: 14.0 to 18.0%, Ni: 5.0 to 8.0%, Mo: 1.5 to 3.5%, Cu: 0.5 to 3.5%, Al: 0.05% or less, V: 0.20% or less, N: 0.01 to 0.15%, and O: 0.006% or less, the balance being Fe and incidental impurities, and which satisfies predetermined relations.

Patent Literature 2 discloses a high-strength stainless steel seamless pipe for oil country tubular goods that achieves a yield strength of 655 MPa or more by having a composition which includes, in mass %, C: 0.005 to 0.05%, Si: 0.05 to 0.50%, Mn: 0.20 to 1.80%, P: 0.030% or less, S: 0.005% or less, Cr: 12.0 to 17.0%, Ni: 4.0 to 7.0%, Mo: 0.5 to 3.0%, Al: 0.005 to 0.10%, V: 0.005 to 0.20%, Co: 0.01 to 1.0%, N: 0.005 to 0.15%, and O: 0.010% or less, the balance being Fe and incidental impurities, and which satisfies predetermined relations.

Patent Literature 3 discloses a high-strength stainless steel pipe for oil wells that exhibits high strength and high corrosion resistance by having a composition which includes, in mass %, C: 0.05% or less, Si: 0.50% or less, Mn: 0.10 to 1.80%, P: 0.03% or less, S: 0.005% or less, Cr: 14.0 to 17.0%, Ni: 5.0 to 8.0%, Mo: 1.0 to 3.5%, Cu: 0.5 to 3.5%, Al: 0.05% or less, V: 0.20% or less, N: 0.03 to 0.15%, and O: 0.006% or less, and further includes one or two selected from Nb: 0.2% or less and Ti: 0.3% or less, the balance being Fe and incidental impurities, and also by having microstructures in which MC carbonitrides in precipitates represent 3.0 mass % or more of the mass of all the precipitates.

Patent Literature 4 discloses a high-strength stainless steel seamless pipe for oil country tubular goods that has a composition containing Cr and Ni and has microstructures principally including tempered martensite phases. The composition of the high-strength stainless steel pipe for oil country tubular goods satisfies Cr/Ni≤5.3, and the steel pipe has a superficial microstructure that includes a phase which shows a white color when etched with a Vilella etching solution, the white phase having a thickness of 10 μm or more and 100 μm or less from the outer surface of the pipe in the wall thickness direction and being dispersed so as to represent an area fraction of 50% or more of the outer surface of the pipe.

Patent Literature 5 discloses a high-strength martensitic stainless steel seamless pipe for oil wells that has a yield strength of 655 to 862 MPa and a yield ratio of 0.90 or more and is improved in carbon dioxide gas corrosion resistance and sulfide stress corrosion cracking resistance by having a composition including, in mass %, C: 0.01% or less, Si: 0.5% or less, Mn: 0.1 to 2.0%, P: 0.03% or less, S: 0.005% or less, Cr: 14.0 to 15.5%, Ni: 5.5 to 7.0%, Mo: 2.0 to 3.5%, Cu: 0.3 to 3.5%, V: 0.20% or less, Al: 0.05% or less, and N: 0.06% or less, the balance being Fe and incidental impurities.

### PATENT LITERATURE

PTL 1: WO 2004/001082
PTL 2: WO 2017/168874
PTL 3: Japanese Unexamined Patent Application Publication No. 2005-105357
PTL 4: WO 2015/178022
PTL 5: Japanese Unexamined Patent Application Publication No. 2012-136742

### SUMMARY OF THE INVENTION

To enhance the recovery of crude oil, a technique called water injection is recently used in which water is injected into the underground through a seamless steel pipe. Seawater is abundant and is therefore used frequently in water injection. Chloride ions, dissolved oxygen, microorganisms, and the like present in seawater are corrosive and are therefore sometimes removed. Because of the associated costs, however, seawater is often injected without any treatment. Seamless steel pipes used in such an environment require high corrosion resistance. While the techniques described in Patent Literatures 1 to 5 offer a good resistance to carbon dioxide gas corrosion, the crevice corrosion resistance in an untreated seawater environment is insufficient. Furthermore, low-temperature toughness is also required on the background of active developments taking place in cold districts, deep-sea floors, and the like.

To solve the problems in the art discussed above, an object of the present invention is to provide a high-strength stainless steel seamless pipe for oil wells that has high strength and excellent low-temperature toughness and excels in crevice corrosion resistance in an untreated seawater environment.

The term “high strength” in the present invention means that the yield strength YS is 110 ksi (758 MPa) or more.

The term “excellent low-temperature toughness” means that a V-notch test specimen (10 mm thick) having a longitudinal direction perpendicular to the forming direction and being notched along the forming direction shows an absorbed energy vE₋₁₀ of 40 J or more when tested by a Charpy impact test in accordance with JIS Z 2242 at a Charpy impact test temperature of −10° C.

In the present invention, the phrase “excel in crevice corrosion resistance in untreated seawater” means that when a creviced test specimen is submerged in artificial seawater (water temperature: 25° C., saturated with air at 1 atm) for 30 days, the test specimen after the corrosion test has no 0.1 mm or deeper crevice corrosions on the surface of the test specimen according to 10× magnifying glass observation.

The procedures of the above tests will be described in detail in EXAMPLES later.

To achieve the above-mentioned object, the present inventors carried out intensive studies on the influence of chemical compositions of stainless steel pipes on the crevice corrosion resistance in an untreated seawater environment. As a result, the present inventors have found that the chemical composition of a stainless steel material needs to be controlled so that the contents of Cr, Mo, Cu, Ni, W, and Co will satisfy relation (1):

$$Cr + 0.22 \times Ni + 0.38 \times ( Mo + 0.5 \times W ) + 0.89 \times Cu + 0.09 \times Co \geq 21.4 . \qquad ( 1 )$$

Here, Cr, Ni, Mo, W, Cu, and Co in relation (1) indicate the contents (mass %) of the respective elements and are zero when the element is absent.
The present inventors have further found that in order to achieve the desired low-temperature toughness while satisfying the crevice corrosion resistance, it is necessary to control the chemical composition so that the contents of Nb and Co will satisfy relation (2):

$$Co - Nb \geq 0.13 . \qquad ( 2 )$$

Here, Co and Nb in relation (2) indicate the contents (mass %) of the respective elements.

The present invention has been completed based on the above findings and also by further studies. Specifically, the gist of the present invention is as follows.
[1] A high-strength stainless steel seamless pipe for oil wells having a chemical composition including, in mass %:
C: 0.002 to 0.050%,
Si: 0.05 to 0.50%,
Mn: 0.04 to 1.80%,
P: 0.030% or less,
S: 0.0020% or less,
Cr: 16.0 to 20.0%,
Ni: 4.0 to 7.5%,
Mo: 1.5 to 3.7%,
Al: 0.005 to 0.10%,
N: 0.002 to 0.15%,
Co: 0.2 to 1.0%,
Nb: 0.005 to 0.20%, and
O: 0.010% or less,
and further including one or two selected from Cu: 3.5% or less and W: 3.5% or less, the balance being Fe and incidental impurities,
the chemical composition satisfying relation (1) and relation (2):

$$Cr + 0.22 \times Ni + 0.38 \times ( Mo + 0.5 \times W ) + 0.89 \times Cu + 0.09 \times Co \geq 21.4 \qquad ( 1 )$$

wherein Cr, Ni, Mo, W, Cu, and Co in relation (1) indicate the contents (mass %) of the respective elements and are zero when the element is absent,

$$Co - Nb \geq 0.13 \qquad ( 2 )$$

wherein Co and Nb in relation (2) indicate the contents (mass %) of the respective elements,
the high-strength stainless steel seamless pipe having a yield strength of 758 MPa or more and an absorbed energy vE₋₁₀ in a Charpy impact test at a test temperature of −10° C. of 40 J or more.
[2] The high-strength stainless steel seamless pipe for oil wells according to [1], wherein the chemical composition further includes, in mass %, one, or two or more selected from:
V: 0.50% or less,
Ti: 0.20% or less,
Zr: 0.20% or less,
B: 0.01% or less,
REM: 0.01% or less,
Ca: 0.0100% or less,
Sn: 0.20% or less,
Sb: 0.50% or less,
Ta: 0.1% or less, and
Mg: 0.0100% or less.

The high-strength stainless steel seamless pipe for oil wells according to the present invention has high strength and excellent low-temperature toughness and excels in crevice corrosion resistance in untreated seawater.

### DETAILED DESCRIPTION OF EMBODIMENTS OF THE INVENTION

The present invention will be described in detail below. The scope of the present invention is not limited to the embodiments discussed below.

First, the chemical composition of the high-strength stainless steel seamless pipe for oil wells according to the present invention, and the reasons why the chemical composition is thus limited will be described. In the following, references to mass % are simply written as “g” unless otherwise specified.

### C: 0.002 to 0.050%

Carbon is an important element that increases the strength of martensitic stainless steel. In the present invention, 0.002% or more carbon needs to be contained in order to ensure the desired strength in the present invention. Thus, the C content is limited to 0.002% or more. The C content is preferably 0.010% or more, more preferably 0.015% or more, and still more preferably 0.020% or more. The C content is most preferably 0.022% or more. On the other hand, more than 0.050% carbon lowers the strength and also deteriorates the crevice corrosion resistance in an untreated seawater environment. Thus, the C content in the present invention is limited to 0.050% or less. The C content is preferably 0.040% or less, more preferably 0.035% or less, and still more preferably 0.030% or less. The C content is most preferably 0.028% or less.

### Si: 0.05 to 0.50%

Silicon is an element that acts as a deoxidizing agent. This effect arises when 0.05% or more silicon is present. Thus, the Si content is limited to 0.05% or more. The Si content is preferably 0.10% or more, and more preferably 0.15% or more. The Si content is still more preferably 0.20% or more, and most preferably 0.22% or more. On the other hand, more than 0.50% silicon deteriorates the crevice corrosion resistance in an untreated seawater environment. Thus, the Si content is limited to 0.50% or less. The Si content is preferably 0.45% or less, more preferably 0.40% or less, and still more preferably 0.30% or less. The Si content is most preferably 0.25% or less.

### Mn: 0.04 to 1.80%

Manganese is an element that suppresses & ferrite formation during hot working and enhances hot workability. In the present invention, 0.04% or more manganese needs to be contained. Thus, the Mn content is limited to 0.04% or more. The Mn content is preferably 0.10% or more, more preferably 0.20% or more, and still more preferably 0.25% or more. The Mn content is most preferably 0.35% or more. On the other hand, too much manganese deteriorates the crevice corrosion resistance in an untreated seawater environment. Thus, the Mn content is limited to 1.80% or less. The Mn content is preferably 1.60% or less, more preferably 0.80% or less, still more preferably 0.60% or less, and most preferably 0.40% or less.

### P: 0.030% or Less

Phosphorus is an element that deteriorates the crevice corrosion resistance in an untreated seawater environment. In the present invention, it is preferable to remove as much phosphorus as possible. However, excessive dephosphorization raises the production costs. Thus, the P content is limited to 0.030% or less to ensure industrial implementation at relatively low cost without causing significant deterioration in characteristics. The P content is preferably 0.025% or less, and more preferably 0.020% or less. The P content is still more preferably 0.018% or less, and most preferably 0.015% or less. Incidentally, there is no particular lower limit of the P content. However, the P content is preferably 0.005% or more because, as mentioned earlier, excessive dephosphorization raises the production costs.

### S: 0.0020% or Less

Sulfur significantly lowers hot workability and deteriorates low-temperature toughness by being segregated at prior-austenite grain boundaries. It is therefore preferable to remove as much sulfur as possible. The sulfur segregation at prior-austenite grain boundaries can be suppressed and the desired low-temperature toughness in the present invention can be obtained when the S content is 0.0020% or less. Thus, the S content is limited to 0.0020% or less. The S content is preferably 0.0015% or less. The S content is more preferably 0.0010% or less, and still more preferably 0.0007% or less. Incidentally, there is no particular lower limit of the S content. However, the S content is preferably 0.0005% or more because excessive desulfurization raises the production costs.

### Cr: 16.0 to 20.0%

Chromium is an element that contributes to the crevice corrosion resistance in an untreated seawater environment through the formation of a protective film. In the present invention, 16.0% or more chromium needs to be contained. Thus, the Cr content is limited to 16.0% or more. The Cr content is preferably 16.5% or more, more preferably 16.8% or more, and still more preferably 17.0% or more. The Cr content is most preferably 17.5% or more. On the other hand, more than 20.0% chromium facilitates the occurrence of retained austenite by inhibiting martensite transformation. Consequently, the martensite phase stability is lowered, and the desired strength in the present invention cannot be obtained. In addition, & ferrite phases are precipitated during high-temperature heating to cause a significant decrease in hot workability. Thus, the Cr content is limited to 20.0% or less. The Cr content is preferably 19.5% or less, more preferably 19.0% or less, and still more preferably 18.5% or less. The Cr content is most preferably 18.0% or less.

### Ni: 4.0 to 7.5%

Nickel is an element that acts to strengthen the protective film and thereby to enhance the crevice corrosion resistance in an untreated seawater environment. Furthermore, nickel suppresses the precipitation of & ferrite phases and enhances the hot workability. Furthermore, nickel increases the strength of steel by being dissolved therein. These effects are obtained when 4.0% or more nickel is present. Thus, the Ni content is limited to 4.0% or more. The Ni content is preferably 5.0% or more, more preferably 6.0% or more, and still more preferably 6.1% or more. The Ni content is most preferably 6.3% or more. On the other hand, more than 7.5% nickel facilitates the occurrence of retained austenite by inhibiting martensite transformation. Consequently, the martensite phase stability is lowered, and the strength is lowered. Thus, the Ni content is limited to 7.5% or less. The Ni content is preferably 7.0% or less, and still more preferably 6.5% or less.

### Mo: 1.5 to 3.7%

Molybdenum is an element that increases the resistance to pitting corrosion by Cl⁻ or low pH. In the present invention, 1.5% or more molybdenum needs to be contained. Less than 1.5% molybdenum invites deterioration in carbon dioxide gas corrosion resistance and crevice corrosion resistance in a severely corrosive environment. Thus, the Mo content is limited to 1.5% or more. The Mo content is preferably 2.0% or more, more preferably 2.2% or more, and still more preferably 2.5% or more. The Mo content is most preferably 2.7% or more. On the other hand, more than 3.7% molybdenum gives rise to δ ferrite and deteriorates the hot workability, the carbon dioxide gas corrosion resistance, and the SSC resistance in a low-temperature environment. Thus, the Mo content is limited to 3.7% or less. The Mo content is preferably 3.5% or less, more preferably 3.3% or less, and still more preferably 3.0% or less. The Mo content is most preferably 2.8% or less.

### Al: 0.005 to 0.10%

Aluminum is an element that acts as a deoxidizing agent. This effect is obtained when 0.005% or more aluminum is present. Thus, the Al content is limited to 0.005% or more. The Al content is preferably 0.01% or more, and more preferably 0.015% or more. The Al content is still more preferably 0.017% or more, and most preferably 0.02% or more. If, on the other hand, more than 0.10% aluminum is contained, the amount of the oxide that is formed is so large that the crevice corrosion resistance is adversely affected. Thus, the Al content is limited to 0.10% or less. The Al content is preferably 0.05% or less, more preferably 0.04% or less, and still more preferably 0.03% or less. The Al content is most preferably 0.025% or less.

### N: 0.002 to 0.15%

Nitrogen is an element that suppresses the formation of δ ferrite at low cost and thereby enhances hot workability. These effects are obtained when 0.002% or more nitrogen is present. Thus, the N content is limited to 0.002% or more. The N content is preferably 0.01% or more, and more preferably 0.02% or more. The N content is still more preferably 0.03% or more, and most preferably 0.04% or more. On the other hand, more than 0.15% nitrogen forms coarse nitrides and lowers the crevice corrosion resistance. Thus, the N content is limited to 0.15% or less. The N content is preferably 0.12% or less, more preferably 0.10% or less, and still more preferably 0.08% or less. The N content is most preferably 0.06% or less.

### Co: 0.2 to 1.0%

Cobalt is an element that enhances crevice corrosion resistance. This effect is obtained when 0.2% or more cobalt is present. Thus, the Co content is limited to 0.2% or more. The Co content is preferably 0.25% or more. The Co content is more preferably 0.3% or more, still more preferably 0.35% or more, and most preferably 0.4% or more. On the other hand, the effect is saturated even when more than 1.0% cobalt is contained. Thus, when cobalt is contained, the Co content is limited to 1.0% or less. The Co content is preferably 0.8% or less, and more preferably 0.7% or less. The Co content is still more preferably 0.65% or less, and most preferably 0.6% or less.

### Nb: 0.005 to 0.20%

Niobium is an element that raises the Ms temperature, and this element is necessary in order to obtain crevice corrosion resistance and high strength at the same time. The effect is obtained when 0.005% or more niobium is present. Thus, the Nb content is limited to 0.005% or more. The Nb content is preferably 0.01% or more, more preferably 0.05% or more, and still more preferably 0.07% or more. The No content is most preferably 0.09% or more. On the other hand, more than 0.20% niobium deteriorates low-temperature toughness. Thus, the Nb content is limited to 0.20% or less. The Nb content is preferably 0.17% or less, more preferably 0.15% or less, and still more preferably 0.13% or less. The Nb content is most preferably 0.11% or less.

### O (Oxygen): 0.010% or Less

In steel, oxygen (O) is present as oxides and adversely affects characteristics. It is therefore desirable to remove as much oxygen as possible. In particular, the crevice corrosion resistance is significantly lowered if the O content exceeds 0.010%. Thus, the O content is limited to 0.010% or less. The O content is preferably 0.007% or less, and more preferably 0.004% or less. The O content is still more preferably 0.003% or less, and most preferably 0.002% or less. The O content is preferably 0.0005% or more because excessive deoxidation raises the production costs.

One or Two Selected from Cu: 3.5% or Less and W: 3.5% or Less

### Cu: 3.5% or Less

Copper, which is an element that strengthens the protective film to enhance the crevice corrosion resistance, may be added as required. The above effects are obtained when 0.5% or more copper is present. Thus, the Cu content is preferably 0.5% or more, and more preferably 0.7% or more. The Cu content is still more preferably 1.0% or more, and most preferably 1.2% or more. On the other hand, adding more than 3.5% copper invites the precipitation of CuS at grain boundaries and deteriorates hot workability. Thus, the Cu content is limited to 3.5% or less. The Cu content is preferably 3.0% or less, more preferably 2.5% or less, and still more preferably 2.0% or less. The Cu content is most preferably 1.5% or less.

### W: 3.5% or Less

Tungsten, which is an element that contributes to strengthening and increases the crevice corrosion resistance, may be added as required. The above effects are obtained when 0.05% or more tungsten is present. Thus, the W content is preferably 0.05% or more, more preferably 0.2% or more, still more preferably 0.3% or more, and most preferably 0.5% or more. On the other hand, the effects are saturated even when more than 3.5% tungsten is contained. Thus, the W content is limited to 3.5% or less. The W content is preferably 3.0% or less, more preferably 2.0% or less, and still more preferably 1.5% or less. The W content is most preferably 1.0% or less.

In the present invention, the phrase that one or two is selected from Cu: 3.5% or less and W: 3.5% or less means that when copper and tungsten are contained, their contents are Cu: 3.5% or less and W: 3.5% or less, and pipes containing more than 3.5% copper or tungsten represent comparative examples.

In the present invention, chromium, nickel, molybdenum, tungsten, copper, and cobalt are contained so that their contents fall in the ranges described above and satisfy relation (1) below:

$$Cr + 0.22 \times Ni + 0.38 \times ( Mo + 0.5 \times W ) + 0.89 \times Cu + 0.09 \times Co \geq 21.4 . \qquad ( 1 )$$

Here, Cr, Ni, Mo, W, Cu, and Co in relation (1) indicate the contents (mass %) of the respective elements and are zero when the element is absent.

If the value of the left-hand side of relation (1) (the value of “Cr+0.22×Ni+0.38×(Mo+0.5×W)+0.89×Cu+0.09×Co”) is less than 21.4, the crevice corrosion resistance in an untreated seawater environment is lowered. Thus, in the present invention, chromium, nickel, molybdenum, tungsten, copper, and cobalt are contained so as to satisfy relation (1). That is, the value of the left-hand side of relation (1) is limited to 21.4 or more. The value of the left-hand side of relation (1) is preferably 21.6 or more, more preferably 21.8 or more, and still more preferably 22.0 or more. There is no particular upper limitation of the value of the left-hand side of relation (1). To avoid an increase in cost by excessive addition of alloying elements and to reduce the decrease in strength, it is preferable that the value of the left-hand side of relation (1) be 26.0 or less. The value is more preferably 24.0 or less, and still more preferably 23.8 or less.

Furthermore, in the present invention, cobalt and niobium are contained so that their contents fall in the ranges described above and satisfy relation (2) below:

$$Co - Nb \geq 0.13 . \qquad ( 2 )$$

Here, Co and Nb in relation (2) indicate the contents (mass %) of the respective elements.

As already described, the desired crevice corrosion resistance in an untreated seawater environment can be obtained by controlling the left-hand side of relation (1) to 21.4 or more. This control requires that chromium, nickel, molybdenum, tungsten, copper, and cobalt be contained in the appropriate amounts. Of those elements described above, the elements except cobalt significantly lower the Ms temperature and destroy the desired high strength when contained in excessively large amounts. On the other hand, adding niobium is effective to raise the Ms temperature but too much niobium deteriorates low-temperature toughness. Cobalt enhances crevice corrosion resistance without lowering the Ms temperature, and excellent crevice corrosion resistance, high strength, and low-temperature toughness can be concurrently satisfied by adding at least 0.13% more cobalt than niobium. If the value of the left-hand side of relation (2) (the value of “Co—Nb”) is less than 0.13, low-temperature toughness is lowered. Thus, in the present invention, cobalt and niobium are contained so as to satisfy relation (2). The value of the left-hand side of relation (2) is preferably 0.13 or more. The value of the left-hand side of relation (2) is preferably 0.17 or more, more preferably 0.20 or more, and still more preferably 0.30 or more. There is no particular upper limitation of the value of the left-hand side of relation (2). To avoid an increase in cost by excessive addition of alloying elements and to reduce the decrease in strength, it is preferable that the value of the left-hand side of relation (2) be 1.00 or less. The value of the left-hand side of relation (2) is more preferably 0.80 or less.

In the present invention, the balance after the components described above is iron (Fe) and incidental impurities.

The components described above are the basic components. The basic components alone can offer the desired characteristics of the high-strength stainless steel seamless pipe for oil wells according to the present invention. The pipe of the present invention may contain the following selective elements as required in addition to the basic components described hereinabove. The elements described below, namely, vanadium, titanium, zirconium, boron, rare earth metal, calcium, tin, antimony, tantalum, ang magnesium may be added as required and may represent 0%. One, or two or more selected from V: 0.50% or less, Ti: 0.20% or less, Zr: 0.20% or less, B: 0.01% or less, REM: 0.01% or less, Ca: 0.0100% or less, Sn: 0.20% or less, Sb: 0.50% or less, Ta: 0.1% or less, and Mg: 0.0100% or less.

### V: 0.50% or Less

Vanadium, which is an element that enhances the strength of steel by way of precipitation strengthening, may be added as required. The above effect is obtained when 0.005% or more vanadium is present. Thus, the V content is preferably 0.005% or more. The V content is more preferably 0.03% or more, and still more preferably 0.04% or more. The V content is most preferably 0.05% or more. On the other hand, more than 0.50% vanadium causes a decrease in low-temperature toughness. Thus, when vanadium is added, the V content is limited to 0.50% or less. The V content is preferably 0.40% or less, and more preferably 0.30% or less. The V content is still more preferably 0.25% or less, and most preferably 0.20% or less.

### Ti: 0.20% or Less

Titanium may be added as required. Titanium is an element that is found in oxide or sulfide inclusions and enhances the chemical stability of the inclusions, thereby enhancing the crevice corrosion resistance in an untreated seawater environment. These effects are obtained when 0.002% or more titanium is present. Thus, the Ti content is preferably 0.002% or more. The Ti content is more preferably 0.003% or more. If, on the other hand, the Ti content is more than 0.20%, TiN is precipitated as inclusions to deteriorate the crevice corrosion resistance. Thus, when titanium is added, the Ti content is limited to 0.20% or less. The Ti content is preferably 0.15% or less, and more preferably 0.10% or less. The Ti content is still more preferably 0.07% or less, and most preferably 0.05% or less.

### Zr: 0.20% or Less

Zirconium, which is an element contributing to strength increasing, may be added as required. The above effect is obtained when 0.01% or more zirconium is present. Thus, the Zr content is preferably 0.01% or more, and more preferably 0.02% or more. On the other hand, the effect is saturated even when more than 0.20% zirconium is contained. Thus, when zirconium is added, the Zr content is limited to 0.20% or less. The Zr content is preferably 0.17% or less, more preferably 0.13% or less, and still more preferably 0.10% or less. The Zr content is most preferably 0.07% or less.

### B: 0.01% or Less

Boron, which is an element contributing to strength increasing, may be added as required. The above effect is obtained when 0.0005% or more boron is present. Thus, the B content is preferably 0.0005% or more, more preferably 0.001% or more, and still more preferably 0.002% or more. On the other hand, more than 0.01% boron deteriorates hot workability. Thus, when boron is added, the B content is limited to 0.01% or less. The B content is preferably 0.007% or less, and more preferably 0.005% or less. The B content is still more preferably 0.003% or less.

### REM: 0.01% or Less

Rare earth metal (REM), which is an element contributing to improvements in crevice corrosion resistance, may be added as required. The above effect is obtained when 0.0005% or more rare earth metal is present. Thus, the REM content is preferably 0.0005% or more, and more preferably 0.001% or more. The REM content is still more preferably 0.0015% or more. On the other hand, the effect is saturated even when more than 0.01% rare earth metal is added, and the addition will not produce the corresponding effect and is economically disadvantageous. Thus, when rare earth metal is added, the REM content is limited to 0.01% or less. The REM content is more preferably 0.007% or less. The REM content is still more preferably 0.005% or less, and most preferably 0.003% or less.

### Ca: 0.0100% or Less

Calcium, which is an element contributing to improvements in crevice corrosion resistance, may be added as required. The above effect is obtained when 0.0005% or more calcium is present. Thus, the Ca content is preferably 0.0005% or more. The Ca content is more preferably 0.0010% or more. The Ca content is still more preferably 0.0015% or more. If, on the other hand, the Ca content is more than 0.0100%, the number density of coarse calcium inclusions is increased and the desired crevice corrosion resistance cannot be obtained. Thus, when calcium is added, the Ca content is limited to 0.0100% or less. The Ca content is more preferably 0.0070% or less. The Ca content is still more preferably 0.0050% or less, and most preferably 0.0030% or less.

### Sn: 0.20% or Less

Tin, which is an element contributing to improvements in crevice corrosion resistance, may be added as required. The above effect is obtained when 0.02% or more tin is present. Thus, the Sn content is preferably 0.02% or more, and more preferably 0.05% or more. The Sn content is still more preferably 0.07% or more. On the other hand, the effect is saturated even when more than 0.20% tin is added, and the addition will not produce the corresponding effect and is economically disadvantageous. Thus, when tin is added, the Sn content is limited to 0.20% or less. The Sn content is more preferably 0.15% or less. The Sn content is still more preferably 0.13% or less, and most preferably 0.10% or less.

### Sb: 0.50% or Less

Antimony, which is an element contributing to improvements in crevice corrosion resistance, may be added as required. The above effect is obtained when 0.02% or more antimony is present. Thus, the Sb content is preferably 0.02% or more, and more preferably 0.05% or more. On the other hand, the effect is saturated even when more than 0.50% antimony is added, and the addition will not produce the corresponding effect and is economically disadvantageous. Thus, when antimony is added, the Sb content is limited to 0.50% or less. The Sb content is preferably 0.40% or less, more preferably 0.30% or less, and still more preferably 0.15% or less. The Sb content is most preferably 0.10% or less.

### Ta: 0.1% or Less

Tantalum is an element that increases strength and also has an effect of improving the crevice corrosion resistance. Furthermore, tantalum has similar effects as niobium and thus may replace part of niobium. These effects are obtained when 0.01% or more tantalum is present. Thus, the Ta content is preferably 0.01% or more. The Ta content is more preferably 0.03% or more. The Ta content is still more preferably 0.04% or more. On the other hand, more than 0.1% tantalum causes a decrease in low-temperature toughness. Thus, when tantalum is added, the Ta content is limited to 0.1% or less. The Ta content is preferably 0.09% or less, and more preferably 0.07% or less. The Ta content is still more preferably 0.06% or less, and most preferably 0.05% or less.

### Mg: 0.0100% or Less

Magnesium, which is an element enhancing the crevice corrosion resistance, may be added as required. The above effect is obtained when 0.0002% or more magnesium is present. Thus, the Mg content is preferably 0.0002% or more, and more preferably 0.0004% or more. On the other hand, the effect is saturated even when more than 0.0100% magnesium is added, and the addition will not produce the corresponding effect. Thus, when magnesium is added, the Mg content is preferably limited to 0.0100% or less. The Mg content is preferably 0.0080% or less, more preferably 0.0050% or less, and still more preferably 0.0020% or less. The Mg content is most preferably 0.0010% or less.

The steel pipe microstructures of the high-strength stainless steel seamless pipe for oil wells according to the present invention are not particularly limited. For example, the microstructures are preferably as described below.

The steel pipe microstructures of the high-strength stainless steel seamless pipe for oil wells according to the present invention are preferably composed of martensite phases (tempered martensite phases), retained austenite phases, and ferrite phases.

Because excess retained austenite phases cause a decrease in strength, the area fraction of retained austenite phases is preferably 32% or less. The area fraction of retained austenite phases is more preferably 30% or less, and still more preferably 28% or less. The lower limit is preferably 1% or more. If the amount of ferrite phases is small, strains are concentrated in the ferrite phases during hot working and the hot workability is lowered. Thus, the area fraction thereof is preferably 14% or more. The area fraction of ferrite phases is more preferably 16% or more, and still more preferably 18% or more. The upper limit is preferably 50% or less.

The microstructures may be measured as follows. First, a test specimen for microstructure observation is sampled from a central portion across the wall thickness of a cross section perpendicular to the pipe axis direction and is corroded with Vilella's reagent (a reagent containing picric acid, hydrochloric acid, and ethanol in proportions of 2 g, 10 mL, and 100 mL, respectively). The exposed microstructures are photographed with a scanning electron microscope (magnification: 1000 times), and the image is analyzed with an image analyzer to calculate the microstructure fraction (area %) of ferrite phases.

A test specimen for X-ray diffractometry is ground and polished in such a manner that the measurement face will be a cross section perpendicular to the pipe axis direction (a C cross section). The amount of retained austenite (γ) is measured by X-ray diffractometry. Integrated intensities of X-rays diffracted on (220) plane of γ and (211) plane of α (ferrite) are measured, and the amount of retained austenite is calculated from the equation below. Here, the volume fraction of retained austenite is regarded as the area fraction.

$$γ ( volume fraction ) = 100 / ( 1 + ( I α R γ / I γ R α ) )$$

Here, Iα: integrated intensity of α, Rα: crystallographically theoretically calculated value of α,
Iγ: integrated intensity of γ, and Rγ: crystallographically theoretically calculated value of γ.

The fraction (area %) of martensite phases (tempered martensite phases) is defined as the balance after the deduction of the ferrite phases and the retained γ phases. The fraction or the area fraction of martensite phases is preferably 18% or more, more preferably 30% or more, and is preferably 85% or less, more preferably 75% or less.

Next, a non-limiting embodiment of the method for producing the high-strength stainless steel seamless pipe for oil wells according to the present invention will be described below.

In the following description of the production method, the temperature (° C.) is the surface temperature of the steel pipe material and the steel pipe (the seamless steel pipe after pipe production) unless otherwise specified. For example, the surface temperature may be measured with a radiation thermometer.

In the present invention, the starting material is a steel pipe material having the chemical composition described hereinabove. The steel pipe material as the starting material may be produced by any method without limitation. In an exemplary preferred method, a molten steel having the above-described chemical composition is produced by such a melting method as a converter, and is formed into a steel pipe material, such as a billet, by such a method as a continuous casting method or an ingot making-blooming method.

Subsequently, the steel pipe material is heated (a heating step). The heated steel pipe material is formed into a hollow pipe with a piercer by the Mannesmann-plug mill process or the Mannesmann-mandrel mill process and is thereafter hot worked, thereby forming a pipe (a pipe production step). A seamless steel pipe having the above-described chemical composition with desired dimensions (a predetermined shape) is thus produced. The seamless steel pipe may also be produced by hot press extrusion.

In the step of heating the steel pipe material, the heating temperature is preferably in the range of 1100 to 1350° C. If the heating temperature is below 1100° C., the hot workability is lowered and defects occur frequently during the pipe production. Thus, the heating temperature is preferably 1100° C. or above, and more preferably 1150° C. or above. The heating temperature is still more preferably 1170° C. or above, and most preferably 1200° C. or above. If, on the other hand, the heating temperature is as high as 1350° C. or above, crystal grains undergo coarsening to cause a decrease in low-temperature toughness. Thus, the heating temperature in the heating step is preferably 1350° C. or below. The heating temperature is more preferably 1300° C. or below. The heating temperature is still more preferably 1280° C. or below, and most preferably 1250° C. or below.

After the pipe production, the seamless steel pipe is cooled to room temperature at a cooling rate equal to or higher than that of natural cooling. This ensures that the steel pipe microstructures will be based on martensite phases.

In the present invention, the steel pipe (the seamless steel pipe after pipe production) that has been cooled at a cooling rate equal to or higher than that of natural cooling is preferably subjected to heat treatment (quenching treatment, tempering treatment).

Specifically, the steel pipe (the seamless steel pipe after pipe production) is preferably subjected to quenching treatment in which the steel pipe is reheated to a temperature (a heating temperature) in the range of 850° C. or above and 1120° C. or below, held at the temperature for a predetermined amount of time, and subsequently cooled at a cooling rate equal to or higher than that of natural cooling until the surface temperature of the steel pipe reaches a temperature (a cooling stop temperature) of 100° C. or below. Here, the “cooling rate equal to or higher than that of natural cooling” is 0.01° C./s or more.

In this manner, the martensite phases are ensured and high strength can be achieved. For this reason, the reheating temperature is preferably 850° C. or above.

In order to prevent the coarsening of microstructures and to dissolve intermetallic compounds, the reheating temperature (the heating temperature in the quenching treatment) is more preferably 870° C. or above, and still more preferably 900° C. or above. The reheating temperature is most preferably 950° C. or above. The temperature is preferably in the range of 1120° C. and below. The reheating temperature is more preferably 1100° C. or below, still more preferably 1050° C. or below, and most preferably 1000° C. or below.

To ensure soaking, it is preferable that the steel pipe be held at the reheating temperature for 5 minutes or more. The holding time is more preferably 10 minutes or more, and still more preferably 15 minutes or more. The holding time is preferably 30 minutes or less. The holding time is more preferably 25 minutes or less, and still more preferably 20 minutes or less.

To ensure the desired yield strength (YS) in the present invention, the cooling stop temperature after the quenching treatment is preferably 100° C. or below. The cooling stop temperature is more preferably 75° C. or below, and still more preferably 50° C. or below. The cooling stop temperature is preferably 30° C. or above, and more preferably 40° C. or above.

The steel pipe from the quenching treatment is subsequently subjected to tempering treatment. The tempering treatment is preferably performed in such a manner that the steel pipe is heated to a temperature (a tempering temperature) of 500° C. or above and 650° C. or below, held at the temperature for a predetermined amount of time, and naturally cooled. In place of part or the whole of natural cooling, other cooling, such as water cooling, oil cooling, or mist cooling, may be performed.

If the tempering temperature is below 500° C., the strength is excessively increased to make it difficult to ensure the desired low-temperature toughness. Thus, the tempering temperature is preferably 500° C. or above. The tempering temperature is more preferably 530° C. or above. The tempering temperature is still more preferably 550° C. or above, and most preferably 570° C. or above. In this manner, the steel pipe microstructures will be based on principally including tempered martensite phases, and the seamless steel pipe achieves the desired strength and the desired crevice corrosion resistance in the present invention. If, on the other hand, the tempering temperature is excessively high, fresh martensite phases are precipitated after the tempering and the desired high strength cannot be ensured. Thus, the tempering temperature is preferably 650° C. or below. The tempering temperature is more preferably 640° C. or below, and still more preferably 620° C. or below. The tempering temperature is most preferably 600° C. or below.

To ensure soaking of the material, the steel pipe is preferably held at the above tempering temperature for 10 minutes or more. The holding time is preferably 90 minutes or less.

In the present invention, the quenching treatment and the tempering treatment may be repeated two or more times. In this manner, the low-temperature toughness is enhanced. There is no particular upper limit on the number of times of the quenching and tempering treatments. The number of times is preferably 3 or less to avoid an increase in production costs.

While the above embodiments have illustrated seamless steel pipes, the present invention is not limited thereto. The steel pipe material having the chemical composition described hereinabove may be formed into an oil-well steel pipe in the form of electric resistance welded steel pipe or UOE steel pipe. In this case, the high-strength stainless steel seamless pipe for oil wells of the present invention may be obtained by quenching and tempering the resultant oil-well steel pipe under the treatment conditions described hereinabove.

As described hereinabove, the high-strength stainless steel seamless pipe for oil wells obtained according to the present invention has an absorbed energy vE₋₁₀ of 40 J or more in a Charpy impact test at a test temperature of −10° C., excels in crevice corrosion resistance in untreated seawater, and has high strength with a yield strength YS of 758 MPa or more.

The absorbed energy vE₋₁₀ in a Charpy impact test at a test temperature of −10° C. is 40 J or more. The absorbed energy vE₋₁₀ in a Charpy impact test at a test temperature of −10° C. is preferably 50 J or more, more preferably 60 J or more, and still more preferably 70 J or more. The upper limit is not particularly limited and may be 200 J or less.

The yield strength YS is 758 MPa or more. The yield strength YS is preferably 800 MPa or more, and more preferably 850 MPa or more. The upper limit is not particularly limited and may be 1000 MPa or less.

The intermediate product (such as a billet) in the course of pipe production exhibits excellent hot workability.

The hot workability may be evaluated in the following manner.

A round bar having a diameter across the parallel sides of 10 mm is sampled from the steel pipe material (the cast steel). With a Gleeble tester, the round-bar test piece is heated to 1250° C., held for 100 seconds, cooled to 1000° C. at 1° C./sec, held for 10 seconds, and pulled until fracture. The decrease (%) in sectional area is measured. A smaller decrease in sectional area indicates poorer hot workability. The decrease in sectional area is preferably 60% or more, and more preferably 70% or more. The decrease in sectional area is preferably 90% or less. The decrease in sectional area is more preferably 85% or less.

### EXAMPLES

Hereinbelow, the present invention will be described based on EXAMPLES. The scope of the present invention is not limited to the following EXAMPLES.

Molten steels with a chemical composition described in Table 1 were melted in a vacuum melting furnace to give cast steels (steel pipe materials). All the cast steels obtained were heated at 1250° C. and were hot worked.

Next, the hot-worked steel materials were cut to give test materials. Here, the dimensions of the steel materials were 1100 mm in length, 160 mm in width, and 15 mm in thickness. The test materials were each subjected to a quenching treatment in which the test material was heated to a heating temperature (a reheating temperature) for a soaking time described in Table 2 and was naturally cooled to a cooling stop temperature described in Table 2. Furthermore, a tempering treatment was performed in which the test material was heated at a tempering temperature for a soaking time described in Table 2 and was naturally cooled. Some of the test specimens (the steel pipes Nos. 2 and 4) were subjected to 2 passes of the quenching treatment and the tempering treatment under conditions described in Table 2. These quenching treatment and tempering treatment of the cutout test specimen may be deemed as equal to quenching treatment and tempering treatment of a seamless steel pipe.

The test materials from the quenching and tempering treatments were tested as described below to evaluate tensile characteristics, Charpy impact test characteristics, and corrosion characteristics, and to measure microstructures. The hot workability was evaluated as described below using the cast steels described hereinabove.

### [Evaluation of Tensile Characteristics]

JIS (Japanese Industrial Standards) 14A test pieces for tensile test (φ 6.0 mm) were sampled from the test materials from the quenching and tempering treatments. A tensile test was performed in accordance with JIS Z2241:2011 to determine tensile characteristics (yield strength (YS), tensile strength (TS)). Here, the test pieces were accepted when the yield strength (YS) was 758 MPa or more and were rejected when the yield strength was less than 758 MPa.

### [Evaluation of Charpy Impact Test Characteristics]

V-notch test specimens (10 mm thick) were sampled from the test materials from the quenching and tempering treatments in such a manner that the longitudinal direction of the test specimen would be perpendicular to the forming direction. A Charpy impact test was performed in accordance with JIS Z 2242 (2018). The test temperature was −10° C. The absorbed energy vE₋₁₀ at −10° C. was determined to evaluate the low-temperature toughness. The values obtained with respect to three test specimens were arithmetically averaged to determine the absorbed energy (J) of the stainless steel member. Here, the toughness was evaluated as high and the test specimen was accepted when the absorbed energy vE₋₁₀ at −10° C. was 40 J or more. The test specimen was rejected when the vE₋₁₀ was less than 40 J.

### [Evaluation of Corrosion Characteristics]

The test materials from the quenching and tempering treatments were machined to give corrosion test specimens that had a 12 mmφ hole and were 3 mm in thickness, 20 mm in width, and 50 mm in length. The test specimens were subjected to a corrosion test.

In the corrosion test, a crevice-forming jig made of a fluoro-resin was fitted into the hole of the test specimen and the surface of the test specimen was pressed at a torque of 20 N/mm² to create crevices. Artificial seawater (liquid temperature: 25° C.) was used as the test liquid. The corrosion test specimens were submerged for a period of 30 days. During the test, the test liquid was bubbled with air. The corrosion test specimens after the test were inspected with a 10× magnifying glass for the presence or absence of crevice corrosion on the surface of the test specimen. Here, the test specimens were accepted when there was no crevice corrosion (“Absent” in the column “Crevice corrosion” in Table 3) and were rejected when crevice corrosion had occurred (“Present” in the column “Crevice corrosion” in Table 3).

The test specimen was evaluated as “excelling in crevice corrosion resistance” when there was no crevice corrosion.

### [Evaluation of Hot Workability]

A round bar having a diameter across the parallel sides of 10 mm was sampled form the cast steel. With a Gleeble tester, the round-bar test piece was heated to 1250° C., held for 100 seconds, cooled to 1000° C. at 1° C./sec, held for 10 seconds, and pulled until fracture. The decrease (%) in sectional area was measured to evaluate the hot workability. The smaller the decrease in sectional area, the poorer the hot workability.

### [Measurement of Microstructures]

A test specimen for microstructure observation was sampled from the test material from the quenching and tempering treatments, and microstructures were measured. The face for the microstructure observation was a cross section perpendicular to the rolling direction (a C cross section). First, the test specimen for microstructure observation was corroded with Vilella's reagent (a reagent containing picric acid, hydrochloric acid, and ethanol in proportions of 2 g, 10 mL, and 100 mL, respectively). The exposed microstructures were photographed with a scanning electron microscope (acceleration voltage: 15 kV, magnification: 1000 times), and the image was analyzed with an image analyzer (Image-J) to calculate the microstructure fraction (area %) of ferrite phases.

A test specimen for X-ray diffractometry was ground and polished in such a manner that the measurement face would be a cross section perpendicular to the rolling direction (a C cross section). The amount of retained austenite (γ) was measured by X-ray diffractometry. Integrated intensities of X-rays diffracted on (220) plane of γ and (211) plane of α (ferrite) were measured, and the amount of retained austenite was calculated from the equation below. Here, the volume fraction of retained austenite was regarded as the area fraction.

$$γ ( volume fraction ) = 100 / ( 1 + ( I α R γ / I γ R α ) )$$

Here, Iα: integrated intensity of α, Rα: crystallographically theoretically calculated value of α,
Iγ: integrated intensity of γ, and Rγ: crystallographically theoretically calculated value of γ.

The fraction (area %) of martensite phases (tempered martensite phases) was defined as the balance after the deduction of the ferrite phases and the retained γ phases.

The results obtained are described in Table 3.

TABLE 1

| Steel | Chemical composition (mass %) | | | | | | | | | | | | | |
|---|---|---|---|---|---|---|---|---|---|---|---|---|---|---|
| No. | C | Si | Mn | P | S | Cr | Ni | Mo | Al | N | Co | Nb | O | Cu |
| A | 0.010 | 0.10 | 0.49 | 0.017 | 0.0009 | 17.56 | 4.77 | 2.55 | 0.033 | 0.0120 | 0.390 | 0.174 | 0.0068 | 2.60 |
| B | 0.011 | 0.10 | 0.49 | 0.016 | 0.0010 | 16.77 | 5.16 | 3.46 | 0.025 | 0.0080 | 0.390 | 0.151 | 0.0037 | 2.57 |
| C | 0.010 | 0.10 | 0.49 | 0.015 | 0.0010 | 16.70 | 4.94 | 3.42 | 0.021 | 0.0080 | 0.780 | 0.169 | 0.0076 | 2.58 |
| D | 0.012 | 0.09 | 0.52 | 0.017 | 0.0010 | 16.83 | 4.55 | 3.48 | 0.021 | 0.0090 | 0.240 | 0.009 | 0.0061 | 2.48 |
| E | 0.011 | 0.08 | 0.49 | 0.015 | 0.0008 | 16.85 | 4.57 | 3.52 | 0.018 | 0.0110 | 0.230 | 0.009 | 0.0062 | 2.50 |
| F | 0.009 | 0.10 | 0.50 | 0.017 | 0.0011 | 16.85 | 4.67 | 3.49 | 0.019 | 0.0100 | 0.250 | 0.049 | 0.0073 | 2.49 |
| G | 0.010 | 0.11 | 0.52 | 0.016 | 0.0009 | 16.46 | 4.74 | 3.49 | 0.019 | 0.0120 | 0.230 | 0.099 | 0.0100 | 2.49 |
| H | 0.010 | 0.09 | 0.52 | 0.014 | 0.0011 | 16.69 | 4.95 | 3.51 | 0.019 | 0.0080 | 0.230 | 0.200 | 0.0020 | 2.49 |
| I | 0.050 | 0.10 | 1.40 | 0.002 | 0.0019 | 17.87 | 6.89 | 2.13 | 0.099 | 0.0100 | 0.690 | 0.125 | 0.0030 | 2.52 |
| J | 0.049 | 0.20 | 1.18 | 0.029 | 0.0008 | 19.13 | 6.39 | 2.09 | 0.070 | 0.0050 | 0.910 | 0.078 | 0.0011 | 3.34 |
| K | 0.039 | 0.30 | 0.96 | 0.028 | 0.0011 | 19.00 | 6.94 | 2.68 | 0.099 | 0.0070 | 0.980 | 0.069 | 0.0023 | 1.88 |
| L | 0.038 | 0.30 | 0.79 | 0.003 | 0.0011 | 18.71 | 6.22 | 1.79 | 0.095 | 0.0110 | 0.340 | 0.149 | 0.0013 | 0.81 |
| M | 0.036 | 0.20 | 0.07 | 0.004 | 0.0006 | 18.52 | 7.22 | 1.82 | 0.078 | 0.0090 | 0.760 | 0.183 | 0.0082 | 3.48 |
| N | 0.026 | 0.30 | 1.21 | 0.028 | 0.0014 | 18.73 | 5.13 | 3.79 | 0.075 | 0.1310 | 0.280 | 0.074 | 0.0018 | 3.27 |
| O | 0.004 | 0.40 | 1.20 | 0.021 | 0.0006 | 16.58 | 6.76 | 2.29 | 0.089 | 0.0120 | 0.810 | 0.192 | 0.0079 | 2.92 |
| P | 0.028 | 0.10 | 0.07 | 0.024 | 0.0009 | 18.85 | 5.74 | 2.91 | 0.054 | 0.0080 | 0.510 | 0.151 | 0.0045 | 1.85 |
| Q | 0.004 | 0.40 | 0.08 | 0.018 | 0.0016 | 17.54 | 7.00 | 2.66 | 0.076 | 0.0120 | 0.560 | 0.195 | 0.0042 | 3.32 |
| R | 0.041 | 0.40 | 0.88 | 0.003 | 0.0006 | 19.71 | 5.01 | 3.50 | 0.097 | 0.0120 | 0.520 | 0.116 | 0.0056 | 2.49 |
| S | 0.017 | 0.50 | 0.98 | 0.006 | 0.0009 | 19.07 | 5.34 | 3.25 | 0.071 | 0.0070 | 0.950 | 0.143 | 0.0084 | 2.39 |
| T | 0.019 | 0.30 | 0.88 | 0.019 | 0.0006 | 20.05 | 6.17 | 3.08 | 0.023 | 0.0110 | 0.840 | 0.172 | 0.0032 | 0.65 |
| U | 0.041 | 0.20 | 1.56 | 0.025 | 0.0010 | 19.53 | 4.60 | 3.31 | 0.066 | 0.0040 | 0.680 | 0.025 | 0.0081 | 0.50 |
| V | 0.027 | 0.10 | 0.79 | 0.003 | 0.0014 | 19.13 | 4.28 | 1.77 | 0.040 | 0.0110 | 0.580 | 0.127 | 0.0066 | 2.49 |
| W | 0.002 | 0.40 | 0.24 | 0.009 | 0.0007 | 17.59 | 4.40 | 2.87 | 0.069 | 0.0050 | 0.310 | 0.142 | 0.0019 | 3.46 |
| X | 0.027 | 0.10 | 1.72 | 0.016 | 0.0019 | 17.63 | 4.30 | 1.51 | 0.021 | 0.0050 | 0.480 | 0.102 | 0.0022 | 2.24 |
| Y | 0.029 | 0.50 | 0.09 | 0.007 | 0.0019 | 18.66 | 5.88 | 2.34 | 0.074 | 0.0110 | 0.760 | 0.102 | 0.0097 | 2.69 |
| Z | 0.028 | 0.30 | 0.71 | 0.011 | 0.0018 | 17.55 | 6.73 | 3.24 | 0.089 | 0.0100 | 0.490 | 0.036 | 0.0019 | 2.82 |
| AA | 0.038 | 0.20 | 1.50 | 0.018 | 0.0010 | 18.81 | 5.63 | 3.52 | 0.062 | 0.0080 | 0.690 | 0.067 | 0.0070 | 3.18 |
| AB | 0.025 | 0.30 | 0.94 | 0.010 | 0.0018 | 17.13 | 7.21 | 2.80 | 0.094 | 0.0060 | 0.550 | 0.153 | 0.0055 | 2.84 |
| AC | 0.023 | 0.20 | 0.51 | 0.011 | 0.0014 | 17.60 | 7.58 | 3.51 | 0.072 | 0.0080 | 0.810 | 0.137 | 0.0012 | 0.59 |
| AD | 0.040 | 0.29 | 0.78 | 0.001 | 0.0012 | 18.69 | 6.23 | 3.30 | 0.094 | 0.0090 | 0.340 | 0.149 | 0.0013 | 0 |
| AE | 0.011 | 0.11 | 0.48 | 0.017 | 0.0008 | 17.46 | 4.67 | 2.65 | 0.034 | 0.0130 | 0.390 | 0.174 | 0.0068 | 2.5 |
| | | | | | | | | | | | | | Left-hand | Left-hand |
| | Steel | Chemical composition (mass %) | | | | | | | | | | | side of | side of |
| | No. | W | V | Ti | Zr | B | REM | Ca | Sn | Sb | Ta | Mg | relation (1)^{*1} | relation (2) |
| | A | 0 | 0 | 0 | 0.02 | 0.0075 | 0.0052 | 0 | 0 | 0 | 0 | 0 | 21.9 | 0.216 |
| | B | 0 | 0 | 0 | 0 | 0 | 0 | 0.0029 | 0 | 0 | 0 | 0 | 21.5 | 0.239 |
| | C | 0 | 0 | 0 | 0 | 0.0015 | 0 | 0 | 0.09 | 0.11 | 0 | 0 | 21.5 | 0.611 |
| | D | 0 | 0.002 | 0.002 | 0 | 0 | 0 | 0 | 0.07 | 0 | 0 | 0.0100 | 21.4 | 0.231 |
| | E | 0 | 0.002 | 0 | 0 | 0 | 0 | 0 | 0 | 0 | 0 | 0 | 21.4 | 0.221 |
| | F | 0 | 0.001 | 0 | 0 | 0 | 0 | 0.0040 | 0 | 0 | 0 | 0 | 21.4 | 0.201 |
| | G | 0 | 0.001 | 0.001 | 0 | 0 | 0 | 0 | 0.06 | 0 | 0.062 | 0 | 21.1 | 0.131 |
| | H | 0 | 0.002 | 0.001 | 0 | 0 | 0.0064 | 0.0059 | 0 | 0 | 0 | 0 | 21.3 | 0.030 |
| | I | 0.11 | 0.155 | 0.096 | 0 | 0 | 0 | 0 | 0 | 0 | 0 | 0 | 22.5 | 0.565 |
| | J | 1.55 | 0.392 | 0.167 | 0 | 0 | 0 | 0 | 0 | 0 | 0 | 0 | 24.7 | 0.832 |
| | K | 0.42 | 0.073 | 0.045 | 0 | 0 | 0 | 0 | 0.06 | 0 | 0.018 | 0.0010 | 23.4 | 0.911 |
| | L | 2.17 | 0.194 | 0.109 | 0 | 0 | 0 | 0.0033 | 0 | 0 | 0 | 0 | 21.9 | 0.191 |
| | M | 1.61 | 0.162 | 0.050 | 0 | 0 | 0 | 0 | 0 | 0.10 | 0 | 0.0050 | 24.3 | 0.577 |
| | N | 0.76 | 0.302 | 0 | 0 | 0 | 0.0040 | 0 | 0 | 0 | 0.075 | 0 | 24.4 | 0.206 |
| | O | 2.96 | 0.334 | 0.188 | 0 | 0 | 0 | 0 | 0 | 0 | 0 | 0 | 22.2 | 0.618 |
| | P | 0.91 | 0.031 | 0.007 | 0 | 0 | 0 | 0 | 0 | 0.10 | 0 | 0 | 23.1 | 0.359 |
| | Q | 0.58 | 0.100 | 0.114 | 0 | 0 | 0 | 0.0065 | 0.05 | 0 | 0 | 0 | 23.2 | 0.365 |
| | R | 3.56 | 0.281 | 0.087 | 0 | 0 | 0 | 0 | 0.05 | 0 | 0 | 0 | 25.1 | 0.404 |
| | S | 0.76 | 0.127 | 0.122 | 0 | 0.0059 | 0 | 0 | 0 | 0 | 0 | 0 | 23.8 | 0.807 |
| | T | 0.83 | 0.334 | 0.152 | 0 | 0 | 0 | 0 | 0 | 0 | 0 | 0 | 23.4 | 0.668 |
| | U | 1.56 | 0.019 | 0.180 | 0 | 0 | 0.0019 | 0 | 0 | 0 | 0 | 0 | 22.6 | 0.655 |
| | V | 2.25 | 0.089 | 0.084 | 0 | 0.0017 | 0 | 0 | 0 | 0 | 0 | 0.0010 | 23.4 | 0.453 |
| | W | 2.67 | 0.280 | 0.156 | 0 | 0.0075 | 0 | 0 | 0 | 0 | 0 | 0 | 23.3 | 0.168 |
| | X | 0 | 0.412 | 0.170 | 0 | 0 | 0 | 0 | 0 | 0 | 0 | 0 | 21.2 | 0.378 |
| | Y | 1.01 | 0.361 | 0.054 | 0 | 0 | 0 | 0 | 0 | 0 | 0 | 0.0060 | 23.5 | 0.658 |
| | Z | 0.93 | 0.197 | 0.141 | 0 | 0 | 0 | 0 | 0 | 0 | 0 | 0 | 23.0 | 0.454 |
| | AA | 1.38 | 0.399 | 0.104 | 0 | 0 | 0 | 0 | 0 | 0.04 | 0 | 0 | 24.5 | 0.623 |
| | AB | 3.41 | 0.386 | 0.146 | 0 | 0 | 0 | 0 | 0 | 0 | 0 | 0 | 23.0 | 0.397 |
| | AC | 0 | 0.234 | 0.151 | 0 | 0 | 0 | 0 | 0 | 0 | 0.050 | 0 | 21.2 | 0.673 |
| | AD | 3.17 | 0.194 | 0.107 | 0 | 0 | 0 | 0.0033 | 0 | 0 | 0 | 0 | 21.9 | 0.191 |
| | AE | 0 | 0 | 0 | 0 | 0 | 0 | 0 | 0 | 0 | 0 | 0 | 21.8 | 0.216 |

Underlines indicate being outside the range of the present invention.
^{*1}Cr + 0.22 × Ni + 0.38 × (Mo + 0.5 × W) + 0.89 × Cu + 0.09 × Co ≥21.4•••(1)
Here, Cr, Ni, Mo, W, Cu, and Co in relation (1) indicate the contents (mass %) of the respective elements and are zero when the element is absent.

TABLE 2

| | | Heat treatment | | | | | | |
|---|---|---|---|---|---|---|---|---|
| | | Quenching | | | | Tempering | | |
| | | | | | Cool- | | | |
| | | Heat- | Hold- | | ing | Temper- | Hold- | |
| Steel | | ing | ing | | stop | ing | ing | |
| pipe | Steel | temp. | time | | temp. | temp. | time | Cool- |
| No. | No. | (° C.) | (min) | Cooling | (° C.) | (° C.) | (min) | ing |
| 1 | A | 916 | 20 | Natural | 39 | 600 | 30 | Natural |
| 2 | B | 963 | 20 | Natural | 11 | 600 | 30 | Natural |
| 3 | C | 979 | 20 | Natural | 40 | 600 | 30 | Natural |
| 4 | D | 955 | 20 | Natural | 39 | 600 | 30 | Natural |
| 5 | E | 954 | 20 | Natural | 27 | 600 | 30 | Natural |
| 6 | F | 954 | 20 | Natural | 10 | 600 | 30 | Natural |
| 7 | G | 954 | 20 | Natural | 20 | 600 | 30 | Natural |
| 8 | H | 988 | 20 | Natural | 35 | 600 | 30 | Natural |
| 9 | I | 951 | 20 | Natural | 26 | 600 | 30 | Natural |
| 10 | J | 981 | 20 | Natural | 34 | 600 | 30 | Natural |
| 11 | K | 991 | 20 | Natural | 38 | 600 | 30 | Natural |
| 12 | L | 982 | 20 | Natural | 40 | 600 | 30 | Natural |
| 13 | M | 997 | 20 | Natural | 32 | 600 | 30 | Natural |
| 14 | N | 991 | 20 | Natural | 39 | 600 | 30 | Natural |
| 15 | O | 1093 | 20 | Natural | 36 | 600 | 30 | Natural |
| 16 | P | 985 | 20 | Natural | 14 | 600 | 30 | Natural |
| 17 | Q | 1055 | 20 | Natural | 13 | 600 | 30 | Natural |
| 18 | R | 1039 | 20 | Natural | 29 | 550 | 30 | Natural |
| 19 | S | 980 | 20 | Natural | 37 | 550 | 30 | Natural |
| 20 | T | 993 | 20 | Natural | 13 | 550 | 30 | Natural |
| 21 | U | 990 | 20 | Natural | 32 | 550 | 30 | Natural |
| 22 | V | 945 | 20 | Natural | 15 | 550 | 30 | Natural |
| 23 | W | 1036 | 20 | Natural | 30 | 550 | 30 | Natural |
| 24 | X | 900 | 20 | Natural | 29 | 550 | 30 | Natural |
| 25 | Y | 972 | 20 | Natural | 36 | 550 | 30 | Natural |
| 26 | Z | 1004 | 20 | Natural | 29 | 550 | 30 | Natural |
| 27 | AA | 1006 | 20 | Natural | 40 | 550 | 30 | Natural |
| 28 | AB | 1064 | 20 | Natural | 33 | 550 | 30 | Natural |
| 29 | AC | 1034 | 20 | Natural | 31 | 550 | 30 | Natural |
| 30 | AD | 982 | 20 | Natural | 40 | 600 | 30 | Natural |
| 31 | AE | 916 | 20 | Natural | 39 | 600 | 30 | Natural |

Underlines indicate being outside the range of the present invention.

TABLE 3

| | | Cast steel | | | | | | | | |
|---|---|---|---|---|---|---|---|---|---|---|
| | | characteristics | Microstructures and characteristics of final products | | | | | | | |
| | | Hot workability | Microstructures | | | Tensile characteristics | | Low-temperature | | |
| | | | | | | Yield | Tensile | toughness | Corrosion | |
| Steel | | Decrease in | Tempered | Retained | Ferrite | strength | strength | −10° C. | characteristics | |
| pipe | Steel | sectional area | martensite | austenite | (area | YS | TS | Charpy absorbed | Crevice | |
| No. | No. | (%) | (area %) | (area %) | %) | (MPa) | (MPa) | energy (J) | corrosion | Remarks |
| 1 | A | 75 | 49 | 17 | 34 | 802 | 942 | 76 | Absent | EX. |
| 2 | B | 75 | 47 | 20 | 33 | 807 | 951 | 129 | Absent | EX. |
| 3 | C | 80 | 56 | 14 | 30 | 866 | 983 | 87 | Absent | EX. |
| 4 | D | 81 | 33 | 34 | 33 | 866 | 929 | 127 | Absent | EX. |
| 5 | E | 84 | 57 | 10 | 33 | 872 | 935 | 119 | Absent | EX. |
| 6 | F | 75 | 60 | 8 | 32 | 871 | 923 | 125 | Absent | EX. |
| 7 | G | 79 | 64 | 6 | 30 | 874 | 941 | 74 | Present | COMP. EX. |
| 8 | H | 85 | 49 | 18 | 33 | 837 | 1008 | 27 | Present | COMP. EX. |
| 9 | I | 61 | 73 | 13 | 14 | 760 | 871 | 131 | Absent | EX. |
| 10 | J | 81 | 40 | 32 | 28 | 812 | 1034 | 183 | Absent | EX. |
| 11 | K | 79 | 54 | 16 | 30 | 834 | 944 | 186 | Absent | EX. |
| 12 | L | 79 | 44 | 20 | 36 | 767 | 940 | 138 | Absent | EX. |
| 13 | M | 76 | 57 | 23 | 20 | 766 | 920 | 126 | Absent | EX. |
| 14 | N | 82 | 38 | 23 | 39 | 630 | 810 | 121 | Absent | COMP. EX. |
| 15 | O | 82 | 67 | 1 | 32 | 1013 | 1044 | 127 | Absent | EX. |
| 16 | P | 75 | 49 | 14 | 37 | 794 | 934 | 153 | Absent | EX. |
| 17 | Q | 79 | 63 | 10 | 27 | 819 | 877 | 129 | Absent | EX. |
| 18 | R | 76 | 21 | 27 | 52 | 739 | 901 | 113 | Absent | COMP. EX. |
| 19 | S | 80 | 31 | 21 | 48 | 837 | 962 | 69 | Absent | EX. |
| 20 | T | 78 | 40 | 11 | 49 | 743 | 829 | 119 | Absent | COMP. EX. |
| 21 | U | 78 | 38 | 12 | 50 | 792 | 850 | 158 | Absent | EX. |
| 22 | V | 83 | 32 | 23 | 45 | 888 | 1032 | 72 | Absent | EX. |
| 23 | W | 80 | 45 | 3 | 52 | 761 | 784 | 54 | Absent | EX. |
| 24 | X | 80 | 48 | 21 | 31 | 774 | 896 | 60 | Present | COMP. EX. |
| 25 | Y | 83 | 48 | 17 | 35 | 803 | 941 | 136 | Absent | EX. |
| 26 | Z | 76 | 57 | 17 | 26 | 838 | 946 | 184 | Absent | EX. |
| 27 | AA | 85 | 39 | 21 | 40 | 767 | 889 | 172 | Absent | EX. |
| 28 | AB | 78 | 50 | 20 | 30 | 970 | 1099 | 126 | Absent | EX. |
| 29 | AC | 84 | 17 | 55 | 28 | 345 | 790 | 120 | Present | COMP. EX. |
| 30 | AD | 79 | 32 | 20 | 48 | 761 | 949 | 136 | Absent | EX. |
| 31 | AE | 77 | 49 | 19 | 32 | 801 | 944 | 78 | Absent | EX. |

Underlines indicate being outside the range of the present invention.

1. A high-strength stainless steel seamless pipe for oil wells having a chemical composition comprising, in mass %:
C: 0.002 to 0.050%,
Si: 0.05 to 0.50%,
Mn: 0.04 to 1.80%,
P: 0.030% or less,
S: 0.0020% or less,
Cr: 16.0 to 20.0%,
Ni: 4.0 to 7.5%,
Mo: 1.5 to 3.7%,
Al: 0.005 to 0.10%,
N: 0.002 to 0.15%,
Co: 0.2 to 1.0%,
Nb: 0.005 to 0.20%, and
O: 0.010% or less,
and further comprising one or two selected from Cu: 3.5% or less and W: 3.5% or less, the balance being Fe and incidental impurities,
the chemical composition satisfying relation (1) and relation (2):
$$Cr + 0.22 \times Ni + 0.38 \times ( Mo + 0.5 \times W ) + 0.89 \times Cu + 0.09 \times Co \geq 21.4 \qquad ( 1 )$$
wherein Cr, Ni, Mo, W, Cu, and Co in relation (1) indicate the contents (mass %) of the respective elements and are zero when the element is absent,
$$Co - Nb \geq 0.13 \qquad ( 2 )$$
wherein Co and Nb in relation (2) indicate the contents (mass %) of the respective elements,
the high-strength stainless steel seamless pipe having a yield strength of 758 MPa or more and an absorbed energy vE₋₁₀ in a Charpy impact test at a test temperature of −10° C. of 40 J or more.

2. The high-strength stainless steel seamless pipe for oil wells according to claim 1, wherein the chemical composition further comprises, in mass %, one, or two or more selected from:
V: 0.50% or less,
Ti: 0.20% or less,
Zr: 0.20% or less,
B: 0.01% or less,
REM: 0.01% or less,
Ca: 0.0100% or less,
Sn: 0.20% or less,
Sb: 0.50% or less,
Ta: 0.1% or less, and
Mg: 0.0100% or less.
